(19) United States
(12) Patent Application Publication
(10) Pub. No.: US 2003/0059040 A1
(43) Pub. Date: Mar. 27, 2003

(54) Method and apparatus for increasing the accuracy and speed of correlation attacks

(76) Inventors: Gregory G. Rose, Concord (AU); Philip Michael Hawkes, Burwood (AU)

Correspondence Address: Qualcomm Incorporated, Patents Department, 5775 Morehouse Drive, San Diego, CA, 92121-1714, US

(21) Appl. No.: 10/226,742

(22) Filed: Aug. 22, 2002

Related U.S. Application Data
(60) Provisional application No. 60/314,525, filed on Aug. 22, 2001.

(51) Int. Cl. H04K 3/00

(52) U.S. Cl. 380/1

(57) ABSTRACT

A method and apparatus for decrypting stream ciphers. An SSC2-type stream cipher is decrypted by utilizing the period of LFG output and the correlation of the LSBs of LSFR output. A dynamic probability of error for each bit of a data stream is calculated to determine whether a particular bit should be inverted.

### CLAIM OF PRIORITY UNDER 35 U.S.C. §119

The present Application for Patent claims priority to Provisional Application No. 60/314,525 entitled “METHOD AND APPARATUS FOR INCREASING THE ACCURACY AND SPEED OF CORRELATION ATTACKS” filed Aug. 22, 2001, and assigned to the assignee hereof and hereby expressly incorporated by reference herein.

### BACKGROUND

1. Field

The present disclosed embodiments relates generally to the field of communications, and more specifically to attacking an encryption algorithm.

2. Background

Encryption of data is used in a communication system for security purposes, to ensure that only an authorized target can understand the data. Encryption is the conversion of data (also called plaintext) into cipher text. Cipher text is encrypted data that cannot be easily understood by unauthorized people. Decryption is the process of converting encrypted data back into its original plaintext form.

Encryption algorithms (also called ciphers) are constrained in cellular and personal communications devices because of their lack of computing power for example. Thus, a computationally intensive encryption algorithm such as public key cryptography is not suitable for cellular and personal communications devices.

A software-oriented stream cipher, SSC2, was proposed to meet the constraints of cellular and personal communications devices. M. Zhang, C. Carroll, and A. Chan, The Software-Oriented Stream Cipher SSC2, pages 31-48, 2001. A stream cipher is an encryption algorithm in which an algorithm and a key are applied to each bit in a data stream. A key is a value that is used by an algorithm to lock plaintext, i.e., to convert plaintext into cipher text, and to unlock encrypted text, i.e. to convert cipher text into plaintext. The term cipher also refers to the encrypted data, i.e., the cipher text.

SSC2 is a stream cipher that operates by exclusive-ORing (XORing) the output of two “half-ciphers.” The first half-cipher is constructed from a linear feedback shift register (LFSR) with a non-linear filter/function (NLF). The second half-cipher is constructed from a lagged Fibonacci generator (LFG) and a multiplexor that chooses values from a Fibonacci register.

Cryptanalysis involves the analysis of a cryptosystem, i.e., a system of encryption, with the purpose of breaking the cipher. In other words, cryptanalysis involves the analysis of a method of encryption in order to decrypt the cipher text without knowing the key. A cryptanalyst performs correlation attacks on encrypted data in order to recover the original plaintext data. A correlation attack is the application of an algorithm to encrypted data whereby correlations in the encrypted data are found, which enables the recovery of the original plaintext data from the encrypted data. A cryptanalysis is useful and practical if it is accurate and fast. Thus, it is desirable that the process of analyzing and recovering original data be fast while producing accurate results.

Currently, an accurate and quick method and apparatus for correlation attacks on SSC2 does not exist. Therefore, there is a need in the art for an efficient method and apparatus for increasing the accuracy and speed of correlation attacks on SSC2-type cryptosystems.

### SUMMARY

Embodiments disclosed herein address the above stated needs by disclosing a method for decrypting a stream cipher comprising selecting a data stream having a period Π, determining a number of parity check equations for each bit i in the data stream, determining a number of satisfied parity check equations for each bit i in the data stream, determining a dynamic probability of error for each bit i based on the number of parity check equations for each bit i and the number of satisfied parity check equations for each bit i, and determining whether to invert each bit i based on the dynamic probability of error of each bit i.

### BRIEF DESCRIPTION OF THE DRAWINGS

FIG. 1 is a flowchart of the initialization section of a correlation attack algorithm of an exemplary embodiment;

FIGS. 2A and 2B are flowcharts of the main section of a correlation attack algorithm of an exemplary embodiment; and

FIG. 3 is a block diagram illustrating an apparatus implementing a correlation attack algorithm.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

SSC2 is a stream cipher proposed to meet the constraints of cellular and personal communications devices. The Software-Oriented Stream Cipher SSC2, pages 31-48, 2001. SSC2 is designed for software implementation and is very fast.

SSC2 is based on a linear feedback shift register (LFSR) and a lagged Fibonacci generator (LFG). An LFSR comprises a register that stores a set of bits called the state, and a filter function that is linear modulo two. The linear modulo two function updates the state bit-by-bit. An LFG comprises a Fibonacci register that stores a set of integers modulo N (once again called the state) and a function that is linear modulo N. The linear modulo N function updates the state integer-by-integer. In SSC2, the modulus is N=2³², and the integers are stored as 32-bit blocks called words.

SSC2 achieves its speed by using 32-bit operations. A stream is derived from a 127-bit LFSR, a 17-word LFG and a multiplexor that chooses values from the Fibonacci register of the LFG. The 127-bit register for the LFSR is stored in four 32-bit words (the extra bit is forced to one in the filter function). After the states of the LFSR and LFG are initialized, the following steps are repeated to produce each word of output:

1. Thirty-two (32) bits of the LFSR state are updated simultaneously. A non-linear filter/function (NLF) computes a 32-bit output Nᵢ from the four words in the state of the LFSR.

2. The LFG state is updated. The upper 16 bits and lower 16 bits of a word Yᵢ are swapped to form LFG output Lᵢ.

3. The multiplexor uses the four most significant bits (MSBs) of the updated word to choose one of sixteen (16) values in the LFG state to be the output Mᵢ.

4. The output of the cipher is Zᵢ=(Lᵢ=Mᵢ mod 232)⊕Nᵢ, where ⊕ denotes XOR.

The value Nᵢ is called the output of the LFSR half-cipher, while Vᵢ=(Lᵢ+Mᵢ mod 232) is called the output of the LFG half-cipher.

LFSR Half-Cipher

The LFSR half-cipher comprises the LFSR and the NLF.

The LFSR state is stored as four 32-bit words denoted (Xᵢ₊₃, Xᵢ₊₂, Xᵢ₊₁, Xᵢ). The state is updated to (Xᵢ₊₄, Xᵢ₊₃, Xᵢ₊₂, Xᵢ₊₁) by computing an LFSR state update function. The LFSR state update function is a linear modulo two function,

Xᵢ₊₄=Xᵢ₊₂⊕(Xᵢ₊₁<<31)⊕(Xᵢ>>1),

where ‘<<’ denotes a zero-fill left shift and ‘>>’ denotes a zero-fill right shift and the numbers “31” and “1” are the number of bits to shift. Thus, (x<<31) means to move the rightmost bit 31 bits to the left, thereby making the rightmost bit, the leftmost bit, i.e., the Most Significant Bit, filling in zeros to the right of the leftmost bit. Similarly (x>>1) means shift all the bits right by one bit, leaving the leftmost bit as a zero, and dropping the old rightmost bit. The least significant bit of Xᵢ is ignored.

If this sequence is converted to a bit-stream bₜ, then the bit-sequence satisfies the linear recursion:

bₜ₊₁₂₇=bₜ₊₆₃mod 2.

The characteristic polynomial corresponding to the bit-stream is x¹²⁷+X⁶³+1. This characteristic polynomial is irreducible modulo 2, which means that the bit sequence has a period of (2¹²⁷−1). The LFSR is implemented using a 4-word array S[1] . . . , S[4] containing Xᵢ₊₃, . . . , Xᵢ. At each clock, the LFSR computes A=S[2]⊕(S[3]<<31)⊕(S[4]>>1). The values are shifted up (S[4]←S[3],S[3]←S[2],S[2]←S[1]), and the value of S[1] is set to A. After the LFSR is updated, the NLF output Nᵢ is computed. The NLF uses a variety of operations: XOR, modular addition. SWAP(A): swaps the upper 16-bits and lower 16-bits of A, and \acute{x}ᵢ, which denotes the word Xᵢ with the least significant bit (LSB) forced to 1.

The NLF algorithm is shown below.

1 A←Xᵢ₊₃+\acute{X}ᵢmod 2³², with c1carry;

2 A←SWAP(A);

3 if (c1=0) then A←+.Xᵢ₊₂+A mod 2³² with C2←carry;

4 else A←xᵢ₊₂⊕\acute{x}ᵢ+A mod 2³²with c2←carry;

5 Nᵢ←(Xᵢ₊₁⊕Xᵢ₊₂)+A+c2 mod 2³²;

LFG Half-Cipher

The LFG state consists of 17 words (Yᵢ₊₁₆ . . . , Yᵢ). The state is updated to (Yᵢ₊₁₇, . . . , Y_{i +1}) using the recurrence:

Yᵢ₊₁₇=Yᵢ₊₁₂+Yᵢ mod 2³² (1)

The LFG is implemented using a 17-word array G[1], . . . , G[17]. Key scheduling initializes G[1], . . . , G[17] to the values Y₁₆, . . . , Y₀, and initializes two pointers r and s to 17 and 5, respectively. The output Lᵢ is defined as Lᵢ=SWAP(Yᵢ). The LFG state is updated by computing,

G[r]+G[s]=Yᵢ+Yᵢ₊₁₂=Yᵢ₊₁₇ mod 2³²,

and replacing the value of G[r] (which was Yᵢ) with the value of Yᵢ₊₁₇. The values of r and s are then decreased by 1. When the value of r reaches zero, then the value of r is reset to 17. When the value of s reaches zero, the value of s is reset to 17. The output Mᵢ is defined as,

Mᵢ=G[1+(s+(Yᵢ₊₁₇>>28) mod 16)].

As a result of the reduction modulo 16, the formula for Mᵢ in terms of the sequence {Yᵢ} changes according to the value of i mod 17. After Lᵢ, Mᵢ and Nᵢ are computed, SSC2 outputs Zᵢ=((Lᵢ+Mᵢmod 2³²)⊕Nᵢ), increments i and repeats the process.

Attacking the LFSR Half-Cipher: Background

There are correlations between the least significant bits (LSBs) of certain words output from SSC2. In addition, the Lagged Fibonacci Generator half-cipher has a small period Π, which is 17·2³¹·(2¹⁷−1)≈2⁵². Therefore, if two segments of an SSC2-type output stream with a distance TF apart are exclusive-ored together (XOR), the contributions from the LFG half-cipher are cancelled, leaving the exclusive-or of two filtered LFSR streams to be analyzed.

Computing Z′ᵢ=Zᵢ⊕Z_{i+Π}=Nᵢ⊕N_{i+Π}, allows the LFSR to be attacked in isolation. The correlation in the LSBs of Z′ᵢ words allows an attack to distinguish between the output of SSC2 from a random bit stream. Thus, in an embodiment, an attack exploits the small period Π. An embodiment may decrypt any data stream that has any period Π.

Nᵢ exhibits a correlation to a linear function of the bits of the four-word state Sᵢ. In an embodiment, the linear function of the state Sᵢ is defined as l(S)=S[1]₁₅⊕S[1]₁₆⊕S[2]₃₁, ⊕S[3]₀⊕S[4]₁₆, where the subscript indicates a particular bit of the word (with bit 0 being the least significant bit). Then P(LSB(Zᵢ)=l(S₁))=⅝. Intuitively, three of the l(S) terms are the bits that are XORed to form the least significant bits of Nᵢ; the other two terms contribute to the carry bits that influence how an l(S) result might be inverted or affected by carry propagation.

N_{i+Π} is similarly correlated to the state S_{i+Π}, but because the LFSR state update function is entirely linear, the bits of S_{i+Π} are in turn linear functions of the bits of Sᵢ. Thus, LSB(z′ᵢ) exhibits a correlation to L(Sᵢ)=l(Sᵢ) ⊕l(S_{i+Π}).

The words of the LFSR state are updated according to a bitwise feedback polynomial, but since the word size (32 bits) is a power of two, entire words of the state also obey a recurrence relation, being related by the 32nd power of the feedback polynomial.

If the two streams Zᵢ and Z_{i+Π} were independent, then the correlation probability would be P(LSB(z′ᵢ)=L(Sᵢ))=17/32, which implies an error probability of 1−17/32=0.46875. However these streams are not independent and in practice the error probability is less than the expected 0.46875. This fortuitous occurrence makes a fast correlation attack of an embodiment more efficient.

In an embodiment, the attack on the LFSR half-cipher proceeds by first gathering words z′ᵢ, of which only the least significant bits are utilized in the attack. This requires two segments of a single output stream, separated by Π. Correlation calculations are performed to “correct” the output stream on different amounts of input. In an exemplary embodiment, the amount of input varies between 29,000,000 bits and 32,000,000 bits. Empirically, about ⅔rds of these trials will terminate and produce the correct output L(Sᵢ). Some of the trials might “bog down,” performing a large number of iterations without correcting a significant number of the remaining errors. When a computation “bogs down,” it is arbitrarily terminated after a number of rounds. In an exemplary embodiment, when a computation “bogs down,” it is arbitrarily terminated after a 1000 rounds.

Once an attack is thought to have corrected the cipher output, linear algebra is used to relate the corrected cipher output back to the initial state S₀. The sequence z′ᵢ=zᵢ⊕z_{i+π} can be reconstructed from the initial state to verify that S₀ is correct. If S₀ is incorrect or the attack “bogs down”, then a different number of input bits can be tried.

In an embodiment, an attack on the LFSR half-cipher is a fast correlation attack exploiting a correlation between the least significant bit of the filtered output words, i.e., the LFSR half-cipher output, and at least five of the LFSR state bits. The attack is aided by the fact that a feedback polynomial of the LFSR is only a trinomial X¹²⁷+x⁶³³+1 since correlation attacks work better on polynomials with less terms.

Any particular LFSR is defined by its “characteristic” polynomial, which is the polynomial of least degree that the bits of the LFSR will satisfy. The LFSR will also satisfy other polynomials, for example the square of the characteristic polynomial. A characteristic polynomial is not necessarily a trinomial, but the characteristic polynomial for SSC2 is a trinomial.

If the nonlinear function (NLF) of the LFSR half cipher is perfect, then there should be no useful correlation between the output of the LFSR half-cipher and any linear function of the LFSR state bits. Conversely, if there is a correlation between the LFSR half-cipher output and any linear combination of the LFSR state bits, then the correlation may be used by a fast correlation attack to recover the initial state.

In an embodiment, the output bits of the LFSR Half-Cipher, {Bᵢ}, is equal to a linear function of the output bits from the LFSR, {Aᵢ}, modified by erroneous bits {Eᵢ} with a probability P<0.5. The probability of error P is the opposite of the known correlation. That is, the correlation is equal to (1−P). Put simply, the technique of an embodiment's fast correlation attack utilizes the recurrence relations obeyed by the Bᵢ bits because of their correlation to the Aᵢ bits in order to identify particular bits in an output stream of the LFSR Half-Cipher, which have a high probability of being erroneous. Once the particular bits in the output stream of the LFSR Half-Cipher have been identified as having a high probability of being erroneous (i.e., those Bᵢ bits that differ from the Aᵢ bits), those bits are corrected, i.e. flipped, inverted.

Attacking the LFSR Half-Cipher

An input data stream (also called input data set) for an embodiment's fast correlation attack comprises data from the LSFR half-cipher output.

In an embodiment, a fast correlation attack comprises a plurality of rounds. In each round, particular bits in the output stream of the LFSR Half-Cipher having a high probability of being erroneous are identified and those identified bits are flipped. In each round, the fast correlation attack computes for each bit position j in an input data set, (Bⱼ+(Σ_{iεT}Bᵢ)mod 2), corresponding to each recurrence relation Aⱼ+Σ_{iεT}Aᵢ≡0(mod 2), where the set T is the set of indices for a particular recurrence relation equation. These recurrence relation equations are also called parity check equations. The input data set is the data being cryptanalysed, that is, the output from an SSC2-type encryption system.

There are many parity check equations for a given bit. For example, given bit j=100, there are many parity check equations involving that bit. One parity check equation can have the set T={127, 63}, i.e., B₁₂₇+B₆₃+1. Explicitly adding the jth bit (j=100) where the jth bit is in the middle of the elements of set T yields B₁₂₇+B₁₀₀+B₆₃. Another parity check equation can have the set T={24384, 12351}, i.e., B₂₄₃₈₄+B₁₂₃₅₁+1. Explicitly adding the jth bit (j=100) where the jth bit is left of the elements of set T yields B₁₀₀+B₁₂₃₅₁+B₂₄₄₈₄.

An error probability for bit j: P(Bⱼ≠Aᵢ), is computed based on the number of recurrence relations Bⱼ+ρ_{iεT}Bᵢ≡0(mod 2) satisfied and the number of recurrence relations unsatisfied. The modulus applies to the entire recurrence relation equation. The recurrence relation is satisfied if the sum mod 2 is zero. The result of the sum mod 2 is either zero (0) (satisfies the parity check) or one (1) (does not satisfy the recurrence relation).

If there are enough bits in the output stream of the LFSR half-cipher for a given probability P, then the process of counting unsatisfied equations and correcting bits, in multiple rounds will eventually converge until a consistent LFSR output stream remains meaning that all the parity check equations are simultaneously satisfied. Linear algebra is then used to recover the corresponding initial state of the LFSR.

In each round, the error probability P is dynamically estimated to improve the speed and accuracy of the correlation attack. A correlation attack algorithm has the error probability P as an input parameter to a given round. The error probability P is kept constant throughout the computations of a round. The bit probabilities are reset to P at the beginning of each round. By dynamically estimating the error probability at each round, error probabilities are more likely to be decreased from round to round as erroneous bits are corrected, which results in a greater likelihood of a successful and accurate correlation attack. In addition, the convergence of satisfying the parity check equations will more likely be faster because erroneous bits will more likely be corrected faster with a dynamically estimated error probability.

For a given error probability P, it is straightforward to calculate the proportion of parity check equations expected to be satisfied by the input data. This process is also reversible. Once the proportion α of parity check equations satisfied is determined, the corresponding error probability can be calculated:

Let δ=1−2α, then P=(½(1−δ^{⅓})

Delta is an intermediate variable, the “bias” of the input data away from a 0.5 error probability. Rewriting the equation for P and eliminating δ:

$$P = \frac{1}{2} ( 1 - {( 1 - 2 α )}^{1 / 3} )$$

Since each round begins by counting parity check equations, it is a simple matter to calculate P for that round. With the initial data set, P is fairly close to 0.5. The better the non-linear function of the LSFR Half Cipher, the closer P will be to 0.5 because approximately half the bits will be “wrong,” i.e., have errors. As the correlation attack algorithm proceeds, bits are corrected and P decreases.

In each round, the first pass over the data calculates (and stores) the number of unsatisfied checks for each bit. From the total proportion of parity checks unsatisfied, P is calculated for this round, and from the calculated P, threshold values for the number of unsatisfied parity checks, above which a bit will be considered to be in error, are calculated for each number of parity check equations (different bit positions in the data set will have slightly different numbers of parity check equations, as some “run off the edge of the data”). When P<0.4 it is approximately correct that more than half of the parity checks unsatisfied implies that the probability of the bit being erroneous is greater than 0.5, and the bit should be corrected. However, when P>0.4, more equations need to be unsatisfied before flipping a bit is theoretically justified. The correlation attack algorithm's eventual success is known to be very dependent on these early decisions. A pass is then made through the data, flipping the bits that require it. For each bit that is flipped, the count of unsatisfied parity checks is corrected, not only for that bit, but also for each bit involved in a parity check equation with it. The correction factor is accumulated in a separate array so that the correction is applied to all bits effectively simultaneously. Bits that have no unsatisfied parity checks are noted. In the early rounds, this incremental approach doesn't save very much, but as fewer bits are corrected per round the saving in computation becomes significant.

Correlation Attack Algorithm: Initialization Section

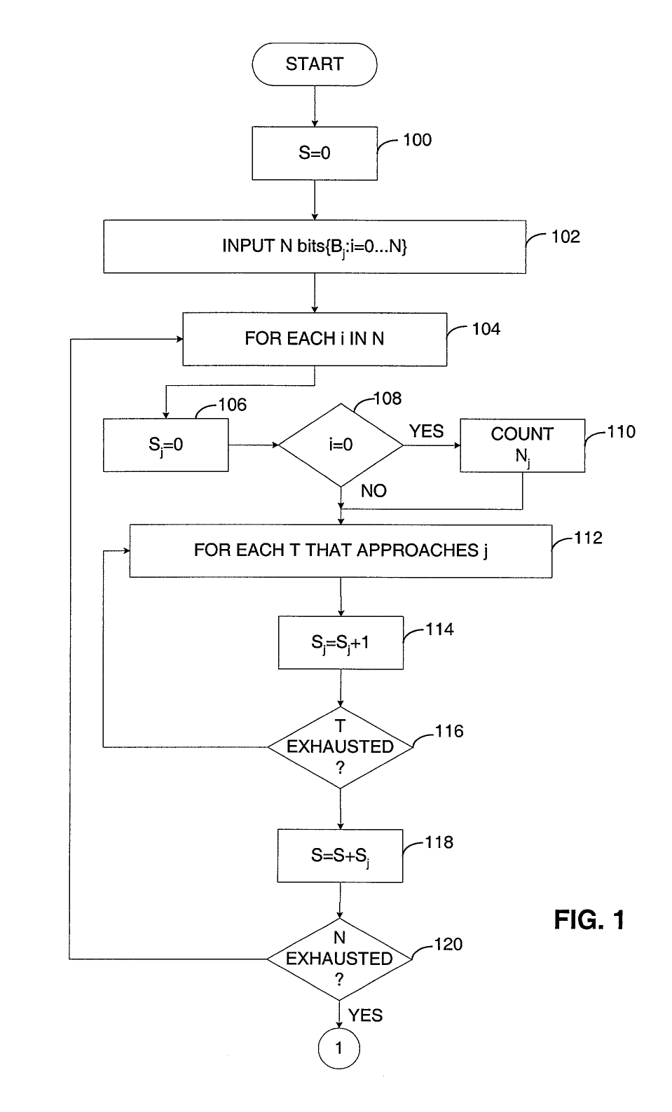

FIG. 1 is a flowchart of the initialization section of a correlation attack algorithm of an exemplary embodiment. In step 100, a total number of satisfied parity checks is initialized to zero. In step 102, N bits of a data stream are input, where Bi: i=0 . . . N. The N bits are taken from the z′ᵢ words of the LFSR half-cipher output.

In step 104, each bit i in N is inspected. In step 106, the number of satisfied parity checks for bit i, i.e., Sᵢ, is initialized to zero. In step 108, a check is made to determine whether index i is zero. If index i is zero meaning that this is the first iteration of going through the input data stream, then in step 110, the total number of parity checks for the ith bit is determined. Thus, the total number of parity checks for the ith bit, Nᵢ, is determined one time only. The total number of parity checks for bit i is a fixed number. After step 110, the flow of control goes to step 112. In step 108, if index i is not zero, the flow of control goes to step 112.

In step 112, each element in set T that approaches i is inspected. That is, each element in the set T for a given bit i is inspected. In step 114, the number of satisfied parity checks for each bit i are counted, i.e., Sᵢ=Sᵢ+1. Sᵢ in the context of the correlation attack algorithm is the number of satisfied parity checks for bit i. In step 116, a check is made to determine whether all the elements of set T have been inspected. If all of the elements in set T have not been inspected, then the flow of control goes to step 112. Otherwise, the flow of control goes to step 118.

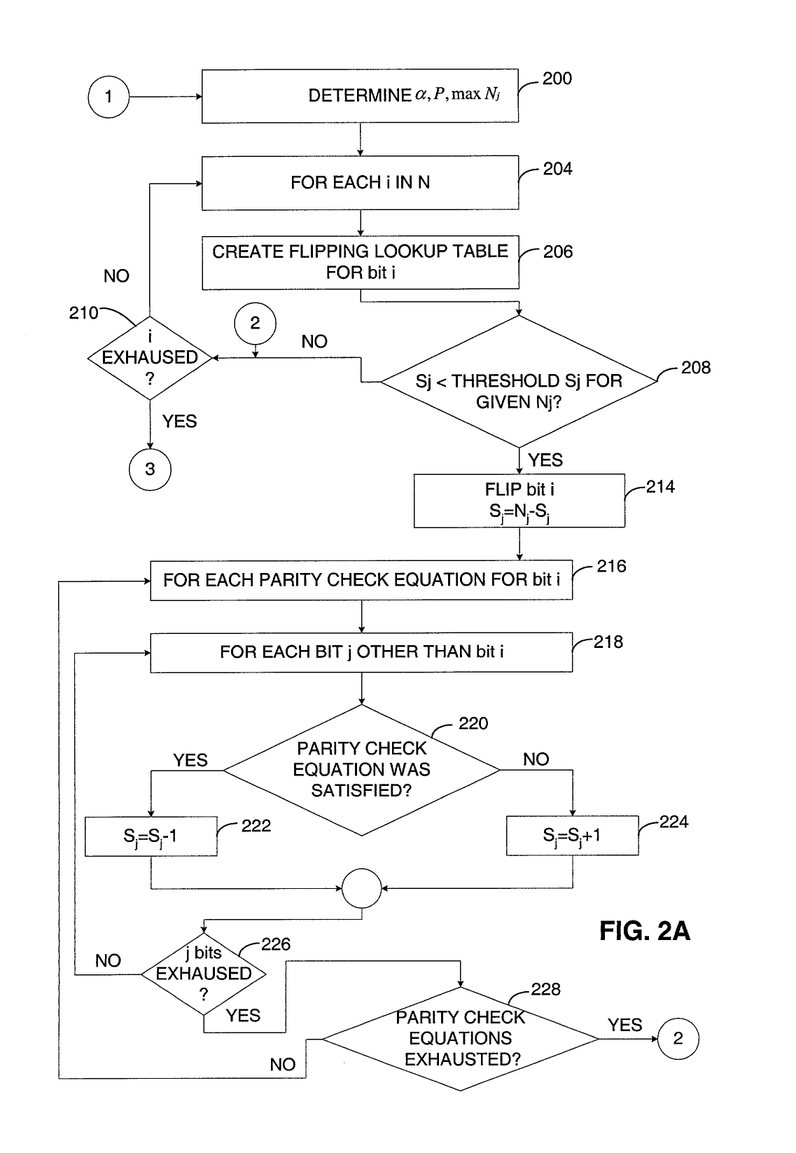

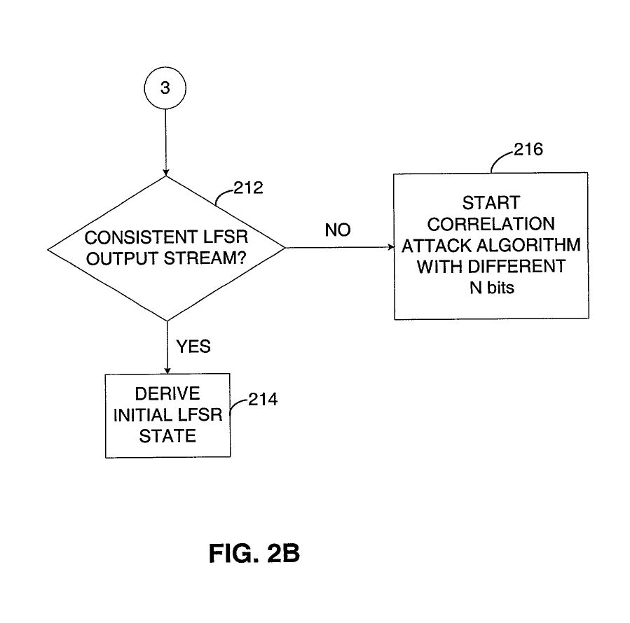

In step 118, the total number of satisfied parity checks for all bits i are accumulated, i.e., ΣSᵢ. In step 120, a check is made to determine whether each bit in N has been inspected. If each bit in N has not been inspected, then the flow of control goes to step 104. That is, the correlation algorithm inspects the next bit of the N bits. If each bit in N has been inspected, then the flow of control goes to step 200 of FIG. 2.

Parity Check Equations

In an exemplary embodiment, parity check equations are created from the characteristic polynomial x¹²⁷+x⁶³+1 and the five polynomials:

x¹⁶¹²⁹+x⁴⁰³³+1

x¹²¹⁶⁰+x⁴¹⁵⁹+1

x¹²²²⁴+x⁸²⁵⁵+1

x¹⁶³⁸³+x¹²²⁸⁸+1

x²⁴³⁸⁴+x¹²³⁵¹+1.

Together the characteristic polynomial and the five polynomials are called seed polynomials since they are used to generate polynomials.

Each polynomial implies a particular set T as shown below.

x¹²⁷+x⁶³+1=>T={127, 63}

x¹⁶¹²⁹+x⁴⁰³³+1=>T={16129, 4033}

x¹²¹⁶⁰+x⁴¹⁵⁹+1=>T={12160, 4159}

x¹²²²⁴+x⁸²⁵⁵+1=>T={12224, 8255}

x¹⁶³⁸³+x¹²²⁸⁸+1=>T={16383, 12288}

x²⁴³⁸⁴+x¹²³⁵¹+1=>T={24384, 12351}

Three potentially useful parity check equations are generated from each polynomial or set T by placing a given jth bit to the left, middle, and right of the elements of T.

For each polynomial, the three parity check equations generated are called the left parity check equation, the middle parity check equation, and the right parity check equation, where bit j is to the left, middle, or right of the other terms in set T, respectively.

Thus, for j=100,

x¹²⁷+x⁶³+1=>T={127,63}=>b₁₀₀+b₁₆₃+b₂₂₇,

b₃₇+b₁₀₀+b₁₆₄,

b₋₂₇+b₃₇+b₁₀₀

For bit j=100 is the left bit, then a parity check equation b₁₀₀+b₁₆₃+b₂₂₇ is generated. b₁₆₃ can be derived by adding 63 to 100 resulting in 163. b₂₂₇ can be derived by adding 127 to 100 resulting in 227. For bit j=100 is the middle bit, then a parity check equation b₃₇+b₁₀₀+b₁₆₄ is generated. b₃₇ can be derived by subtracting 63 from 100 resulting in 37. b₁₆₄ can be derived by adding 127 to 37 resulting in 164. For bit j=100 is the right bit, then a parity check equation b₋₂₇+b₃₇+b₁₀₀ is generated. b₋₂₇ can be derived by subtracting 127 from 100 resulting in −27. b₃₆ can be derived by subtracting 63 from 100 resulting in 37.

Since the third parity check equation runs off the edge of the input data stream, the third parity check equation is not useful. Thus, two useful parity check equations were generated from the polynomial x¹²⁷+x⁶³+1 as shown below.

x¹²⁷+x⁶³+1=>T={27,63}=>b₁₀₀+b₁₆₃+b₂₂₇

b₃₇+b₁₀₀+b₁₆₄

b₋₂₇+b₃₇+b₁₀₀

When a polynomial generates a useful parity check equation, then the square of the polynomial is generated. Thus, in the example above, the square of the polynomial x¹²⁷+x⁶³+1 is generated since the polynomial x¹²⁷+x⁶³+1 generated a useful parity check equation. In fact, the polynomial x¹²⁷+x⁶³+1 generated two useful parity check equations.

The square of the x¹²⁷+x⁶³+1 is the polynomial x²⁵⁴+x¹²⁶+1, which implies a set T={254, 126}. For bit j=100 is the left bit, then a parity check equation b₁₀₀+b₂₂₆+b₃₅₄ is generated. b₂₂₆ can be derived by adding 126 to 100 resulting in 226. b₃₅₄ can be derived by adding 254 to 100 resulting in 354. For bit j=100 is the middle bit, then a parity check equation b₋₁₂₆b₁₀₀+b₁₂₈ is generated, which runs off the edge of the data stream. Thus, the parity check equation b₋₁₂₆+b₁₀₀+b₁₂₈ is not useful. b−₁₂₆ is derived from subtracting 226 from 100 resulting in −126. b₁₂₈ can be derived by adding 254 to −126 resulting in 128. For bit j=100 is the right bit, a parity check equation b₋₁₅₄+b₋₂₆+b₁₀₀ can be generated, which runs off the edge of the data stream. Thus, the parity check equation b₋₁₅₄+b₋₂₆+b₁₀₀ is not useful. b₋₁₅₄ can be derived by subtracting 254 from 100 resulting in −154. b₋₂₆ can be derived by subtracting 126 from 100 resulting in −26. The right parity check equation for the square polynomial does not need to actually be generated since the right parity check equation for the polynomial from which the square polynomial was derived lacked usefulness.

Once a parity check equation is found to be not useful such as a right parity check equation, then there is no need to generate right parity check equations for future squares of a polynomial.

Since two of the parity check equations of the square polynomial are not useful, then only the left parity check equation for the square polynomial is useful. The middle parity check equation is not useful; therefore, when the square polynomial is squared again, there is no need to generate the middle parity check equation in addition to no need to generate the right parity check equation.

x²⁵⁴+x¹²⁶+1=>T={254, 126}=>b₁₀₀+b₂₂₆+b354

b₋₁₂₆+b₁₀₀+b₁₂₈

b₋₁₅₄−b₂₆+b₁₀₀

A polynomial keeps getting squared until it does not yield a useful parity check equation. In the example above, the generation of polynomials from the seed polynomial x¹²⁷+x⁶³+1 will cease for bit j=100 when the left parity check equation's right term runs off the edge of the right-hand side of the data stream. That is, in the example above, the generation of polynomials from the seed polynomial x¹²⁷+x⁶³+1 will cease for bit j=100 when the left parity check equation's right term is greater than the right-most index of the data stream.

Since bit j is only the one hundredth bit in the data stream, the other seed polynomials do not contribute parity check equations since the generated parity check equations for the other seed polynomials runs off the edge of the data stream.

The polynomial generation and parity check equation process is performed for each bit j in a data stream.

Correlation Attack Algorithm: Main Section

FIG. 2 is a flowchart of the main section of a correlation attack algorithm of an exemplary embodiment. In step 200, α, dynamic probability P, and max Nᵢ are determined. a is the ratio of the total number of satisfied parity check equation to the total number of parity check equations. Max Nᵢ is the maximum number of parity checks for a bit in the string of N bits. Put another way, the bit i that has the maximum number of parity checks out of the N bits is the subscript to the Max Nᵢ. The dynamic probability P is determined once α is determined.

α=ΣSᵢ/ΣNᵢ=>P

Once ΣSᵢ and ΣNᵢ are determined, then a dynamic probability P is implied, i.e., P can be determined. In an exemplary embodiment, the dynamic probability P is calculated based on a binomial probability distribution.

In step 204, the correlation attack algorithm loops through each bit i in N. Each iteration of i is a round. In step 206, a flipping lookup table that determines whether a bit i should be flipped is created. The flipping lookup table is created each round. The table is created for the max Nᵢ since creating a table for the max Nᵢ subsumes tables for bits i with a smaller Nᵢ, i.e., tables for bits i with a smaller number of parity check equations. Table 1 shows an example Flipping Lookup Table.

Flipping Lookup Table

TABLE 1

| Nᵢ | Threshold Sᵢ |
|---|---|
| . | . |
| . | . |
| . | . |
| 10 | 5 |
| 11 | 5 |
| 12 | 5 |
| 13 | 6 |
| 14 | 6 |
| 15 | 6 |
| 16 | 7 |
| | etc. |

To generate the Flipping Lookup Table, a threshold Sᵢ is calculated for each Nᵢ. The threshold Sᵢ is the number of satisfied equations at which Sᵢ has to be less than in order to flip bit i.

Threshold Sᵢ is determined by calculating Pᵢ. Pᵢ is the probability that bit is in error and should be flipped. Pᵢ is a function of P, Nᵢ, and Sᵢ.

Given P, the observed probability over the input data that each bit is in error, and N being the number of parity check equations applying to a particular bit, the probability P_{S}, which is the probability that some number S of the N equations are satisfied (the rest being unsatisfied by definition) can be calculated.

To simplify the Pᵢ formula, first we calculate a “bias” B corresponding to P:

B=1−(1−2P)²

By the binomial probability distribution, the probability that there are S satisfied equations out of the N equations is

$${P}_{s} = \frac{{{PB}^{S} ( 1 - B )}^{N - S}}{{{PB}^{S} ( 1 - B )}^{N - S} + ( 1 - P ) {{B}^{N - S} ( 1 - B )}^{S}}$$

The simplest algorithm for determining the threshold Sᵢ is to start a threshold Sᵢ variable at zero and increment the threshold Sᵢ variable for each calculation of Pᵢ until Pᵢ is greater than 0.5. When Pᵢ is less than or equal to 0.5, then the threshold Sᵢ variable result is stored in threshold Sᵢ in the flipping lookup table.

A simple threshold Sᵢ algorithm is shown below.

For threshold Sᵢ variable=0 to Nᵢ

calculate Pᵢ

If Pi≦0.5 then exit for loop

End for loop

threshold Sᵢ=threshold Sᵢ variable

A threshold Sᵢ algorithm is executed for each Nᵢ in the flipping lookup table.

The following pseudocode provides a synopsis for the main section of the correlation attack algorithm once the flipping lookup table has been created.

For each i

Compare Sᵢ to the threshold Sᵢ for a given N

if Sᵢ<the threshold Sᵢ for a given Nᵢ

flip the bit

for each parity check equation, check the other two bits in set T and

correct their Sᵢ counts.

endif

endfor

Once the Flipping Lookup Table has been created in step 206, a check is made to determine whether Sᵢ is less than the threshold Sᵢ for a given Nᵢ. If Sᵢ is less than the threshold Sᵢ for a given Nᵢ, then the flow of control goes to step 214 since bit i needs to be corrected, i.e., flipped, inverted. Otherwise, the flow of control goes to step 210.

In step 214, bit i is corrected. The number of satisfied equations for bit i is updated. The number of satisfied equations for bit i is set to the number of parity check equations for bit i less the previous number of satisfied equations for bit i.

In step 216, the correlation attack algorithm loops through each parity check equation for bit i. In step 218, the correlation attack algorithm loops through each bit j other than bit i for a given parity check equation. Each bit j in a set T for a given parity check equation is inspected.

In step 220, a parity check equation is checked to determine whether it is satisfied for the given bit j. If the parity check equation for a given bit j is satisfied, then it is now unsatisfied once bit i has been flipped. Therefore, in step 222, the number of satisfied parity check equations for bit j is decremented. If the parity check equation for a given bit j is unsatisfied, then it is now satisfied once bit i has been flipped. Therefore, in step 224, the number of satisfied parity check equations for bit j is incremented. The flow of control goes to step 226 after steps 222 and 224.

In step 226, a check is made to determine whether the number of j bits in set T for a given parity check equation has been exhausted. If the j bits in set T have not all been inspected, then the next j bit in set other than bit i is inspected and the flow of control goes to step 218. If the all of the j bits in set T have been inspected, then the flow of control goes to step 228.

In step 228, a check is made to determine whether all of the parity check equations for a given bit i have been inspected. If all of the parity check equations for a given bit i have not been inspected, then the flow of control goes to step 216 and the next parity check equation for a given bit i is inspected. Otherwise, the flow of control goes to step 210.

In step 210, a check is made to determine whether every bit i in N has been checked. If every bit in N has been checked, then the flow of control goes to step 212. If not every bit in N has been checked then the flow of control goes to step 204 and the next bit i is inspected.

Once every bit in N has been checked, then in step 212, a check is made to determine whether a consistent LFSR output stream has been created. If a consistent LFSR output stream has been created, then in step 214 linear algebra is used to recover the initial state of the LFSR corresponding to the LFSR output stream and the correlation attack algorithm is complete. If a consistent LFSR output stream has not been created, then the correlation attack algorithm is started again with a different N bits from the z′ᵢ words of the LFSR half-cipher output.

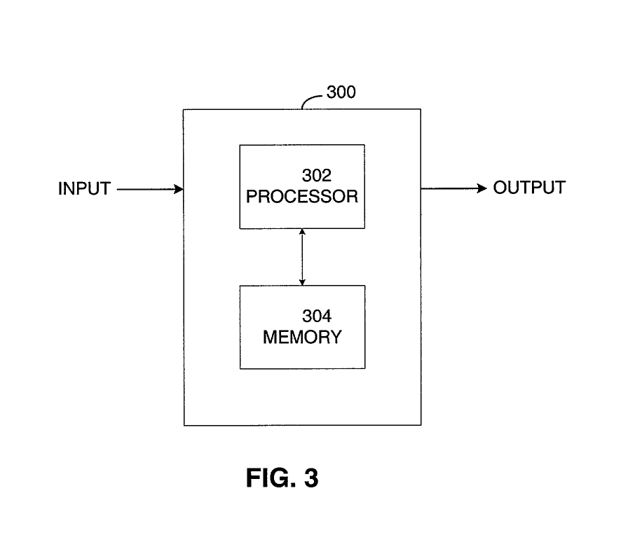

FIG. 3 is a block diagram illustrating an apparatus implementing a correlation attack algorithm. z′ᵢ words of the LFSR half-cipher output is input to apparatus 300. Processor 302 executes the correlation attack algorithm and memory 304 stores the input words, variables, code, and miscellaneous data created and used by the processor 302. The link between the processor 302 and memory 304 may be via any number of units of the apparatus 300.

Those of skill in the art would understand that method steps could be interchanged without departing from the scope of the invention.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

The previous description of the disclosed embodiments is provided to enable any person skilled in the art to make or use embodiments of the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for decrypting a stream cipher comprising:
determining a number of parity check equations for each bit i in a data stream having a period Π;
determining a number of satisfied parity check equations for each bit i in the data stream;
determining a dynamic probability of error for each bit i based on the number of parity check equations for each bit i and the number of satisfied parity check equations for each bit i; and
determining whether to invert each bit i based on the dynamic probability of error of each bit i.

2. An apparatus comprising:
a processor that determines a number of parity check equations for each bit i in a data stream having a period Π, determines a number of satisfied parity check equations for each bit i in the data stream, determines a dynamic probability of error for each bit i based on the number of parity check equations for each bit i and the number of satisfied parity check equations for each bit i, and determines whether to invert each bit i based on the dynamic probability of error of each bit i; and
a memory for storing code and data.

3. A computer readable media embodying a method for decrypting a stream cipher, the method comprising:
determining a number of parity check equations for each bit i in the data stream having a period Π;
determining a number of satisfied parity check equations for each bit i in the data stream;
determining a dynamic probability of error for each bit i based on the number of parity check equations for each bit i and the number of satisfied parity check equations for each bit i; and
determining whether to invert each bit i based on the dynamic probability of error of each bit i.

4. The method of claim 1 wherein the data stream is selected from a larger data stream.

5. The method of claim 1 wherein the dynamic probability of error is calculated based on a binomial probability distribution.
